(19) United States
(12) Patent Application Publication
(10) Pub. No.: US 2005/0057048 A1
(43) Pub. Date: Mar. 17, 2005

(54) Locking mechanism

(76) Inventors: Rafael J. Cobo, North Miami Beach, FL (US); Martin E. Holman IV, Boca Raton, FL (US); Gonzalo E. Labarca, Boca Raton, FL (US); Lawrence R. Stotts, Elgin, IL (US); Oscar J. Pichardo, Parkland, FL (US)

Correspondence Address: Larry G. Brown;Motorola, Inc., Law Department, 8000 West Sunrise Boulevard, Fort Lauderdale, FL, 33322, US

(21) Appl. No.: 10/649,571

(22) Filed: Aug. 26, 2003

(51) Int. Cl. E05C 3/04

(52) U.S. Cl. 292/202

(57) ABSTRACT

The present invention concerns a locking mechanism (100) including a plate (110) and a base (112). The plate has a first projection (122), a second projection (124) and a first surface area (118) for receiving a decorative image (120). The base has a first slot (130) and a second slot (132) in which the first slot runs at least substantially along a first axis (A₁) that is at a predetermined angle with respect to a vertical axis (V₁) of the base, and at least a portion of the second slot runs at least substantially along a second axis (A₂) that is at least substantially perpendicular to the first axis.

### CROSS REFERENCE TO RELATED APPLICATIONS

(Not Applicable)

### BACKGROUND

1. Technical Field

This invention relates in general to locking mechanisms and more particularly, to a locking mechanism for a removable plate.

2. Description of the Related Art

Many manufacturers sell accessories for mobile communications units, such as cellular telephones. For example, consumers may purchase aftermarket products such as removable face plates, portable chargers that permit a user to charge a phone in his or her car and carrying cases. Some consumers may wish to embellish these accessories with cultural icons, particularly icons that are associated with the sporting world.

As an example, a user of a cellular telephone may wish to place on his or her phone a mark associated with a particular sporting team. Currently, however, there is no system or method in place that permits a user to position securely such a mark on a phone or an accessory.

### SUMMARY OF THE INVENTION

The present invention concerns a locking mechanism. The mechanism includes a plate and a base in which the plate has a first projection, a second projection and a first surface area for receiving a decorative image. The base has a first slot and a second slot in which the first slot runs at least substantially along a first axis that is at a predetermined angle with respect to a vertical axis of the base and at least a portion of the second slot runs at least substantially along a second axis that is at least substantially perpendicular to the first axis. The first slot and the second slot detachably receive the first projection when the plate is in a first position. In addition, the first slot locks the first projection, and the second slot locks the second projection when the plate is in a second position such that the plate is detachably coupled to the base.

In one arrangement, the first slot and the second slot can further lock the first projection and the second projection as the plate is turned from the first position to the second position. Also, the first slot and the second slot can unlock the first projection and the second projection when the plate is returned from the second position to the first position. The plate is removable from the base when the plate is in the first position.

In another arrangement, the first projection can have a center portion that is at least substantially circular and at least one wing that is attached to and projects away from the center portion. Further, the first slot can include at least one arc that can engage the center portion of the first projection and at least one extension that can receive the wings of the first projection. The first slot can further include at least one ledge, and the ledges can engage the wings as the plate is turned to and stops at the second position.

The second projection can include a first segment and a second segment that is attached to the first segment. The first segment can be attached to and rise above a second surface area of the plate, and the second segment can be at least substantially parallel with the second surface area. In one embodiment, the second slot can include a protrusion. As an example, the first and second segments can engage the protrusion as the plate is turned from the first position to the second position and can disengage the protrusion when the plate is in the first position. The second slot can further include an arc. At least a portion of the first segment can slide along the arc as the plate is turned from the first position to the second position and from the second position to the first position.

In another embodiment, the system can further include a support unit. Additionally, the base can further include at least one tab, and the support unit can include at least one slot for receiving and engaging the tabs of the base. The support unit can be positioned against an inside surface of a portion of a carrying case. Also, the base can be positioned against an outside surface of the carrying case when the slots of the support unit engage the tabs of the base. In another arrangement, the plate can include a horizontal axis, and the base can include a horizontal axis. As an example, the horizontal axis of the plate can be at a predetermined angle with respect to the horizontal axis of the base when the plate is in the first position. The horizontal axis of the plate can also be at least substantially parallel with the horizontal axis of the base when the plate is in the second position.

The present invention also concerns a plate for a carrying case. The plate includes a first surface area, a second surface area for receiving a decorative image, a first projection and a second projection in which the first and second projections are disposed on the first surface area. The first and second projections are received by first and second slots of a base when the plate is in a first position. Additionally, the first and second projections are engaged by the first and second slots as the plate is turned to and stops at a second position. The plate couples to the base when the first and second projections engage the first and second slots, and the plate decouples from the base when the plate is in the first position.

The present invention also concerns a base of a carrying case. The base includes a first slot and a second slot in which the second slot includes a protrusion. The first and second slots receive a first projection and a second projection of a plate when the plate is in a first position. Further, the first and second slots engage the first and second projections as the plate is turned to and stops at a second position. The plate couples to the base when the first and second slots engage the first and second projections, and the plate decouples from the base when the plate is in the first position.

The present invention also concerns a method of detachably securing a plate to a base of a carrying case. The method includes the steps of inserting a first projection and a second projection of the plate into a first slot and a second slot of the base in which the plate is in a first position and turning the plate towards a second position in which the first slot engages the first projection and the second slot engages the second projection. The method also includes the step of continuing the turning the plate step until the plate reaches the second position.

In one arrangement, the method can further include the steps of turning the plate towards the first position and, when the plate reaches the first position, removing the plate from the base. In another arrangement, the method can also include the steps of positioning a support unit against an inside cover of the carrying case and coupling the base to the support unit such that the base can be positioned against an outside surface of the carrying case. As an example, the plate can include a horizontal axis, and the base can include a horizontal axis. The horizontal axis of the plate can be at a predetermined angle with respect to the horizontal axis of the base when the plate is in the first position. As another example, the horizontal axis of the plate can be at least substantially parallel with the horizontal axis of the base when the plate is in the second position.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is an exploded frontal view of a locking mechanism in accordance with the inventive arrangements;

FIG. 2 is an exploded back view of a locking mechanism in accordance with the inventive arrangements;

FIG. 3 illustrates several components of a locking mechanism in accordance with the inventive arrangements;

FIG. 4 illustrates several components of a locking mechanism in accordance with the inventive arrangements;

FIG. 5 illustrates a flow chart of a method of operating a locking mechanism in accordance with the inventive arrangements;

FIG. 6 illustrates a bottom view of a locking mechanism in which a plate of the locking mechanism is in a first position in accordance with the inventive arrangements;

FIG. 7 illustrates a bottom view of a locking mechanism in which a plate of the locking mechanism is in a second position in accordance with the inventive arrangements.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

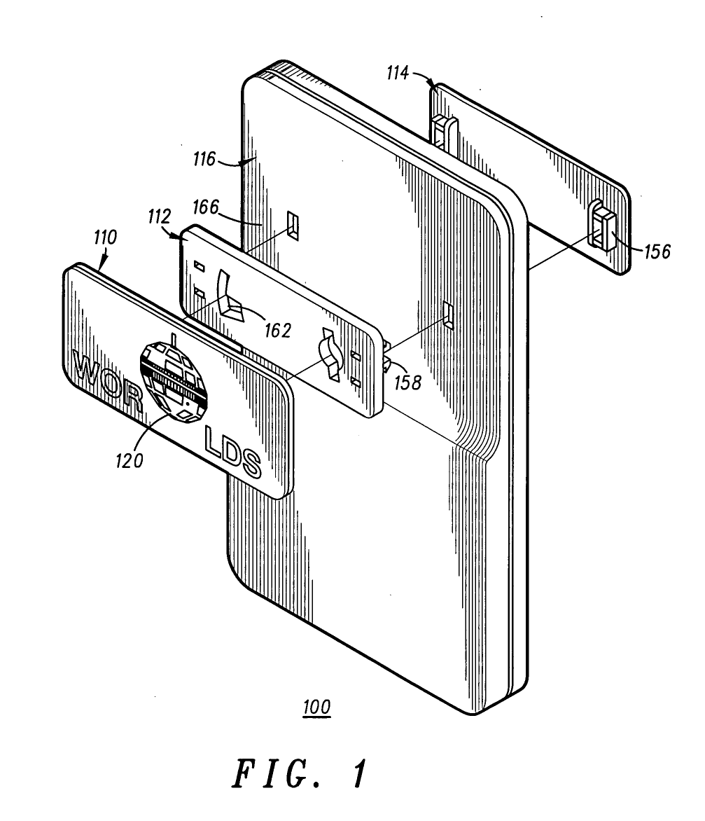

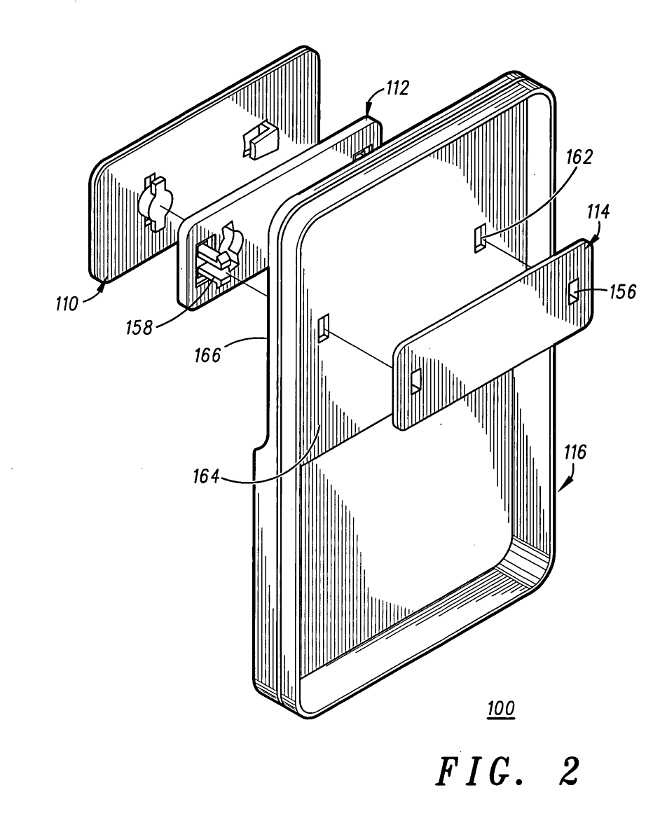

Referring to FIGS. 1 and 2, a frontal view and a back view of a locking mechanism 100 is shown. The mechanism 100 can include a plate 110, a base 112 and a support unit 114. In one arrangement, the locking mechanism 100 can be incorporated into a carrying case 116 (for purposes of clarity, only a portion of the carrying case is shown). It is understood, however, that the invention is not limited in this regard, as the locking mechanism 100 can be implemented into any other suitable device. As an example, the carrying case 116 can be used to house and support a portable electronic device, such as a mobile communications unit.

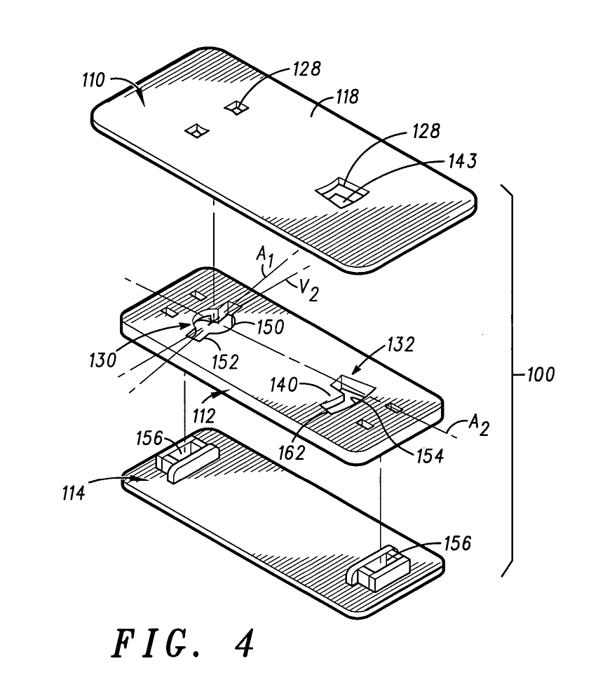

In another arrangement, referring to FIGS. 1 and 4, the plate 110 can include a first surface area 118, and the first surface area 118 can receive a decorative image 120 (see FIG. 1). The decorative image 120 can be, for example, a trademark associated with a company or any other organization, such as a sports team. As another example, the decorative image 120 can be a picture of a setting or an object, a phrase or a collection of symbols. In fact, the decorative image 120 can be any suitable image. The decorative image 120 can be attached or affixed to the first surface area 118 of the plate 110. For example, the decorative image 120 can be affixed to the first surface area 118 with an adhesive. Of course, the decorative image 120 can be secured to the first surface area 118 through any other suitable means. As will be described below, the mechanism 100 can permit a user to detachably couple the plate 110 to the base 112, which can allow the user to couple plates 110 with different decorative images 120 to the base 112.

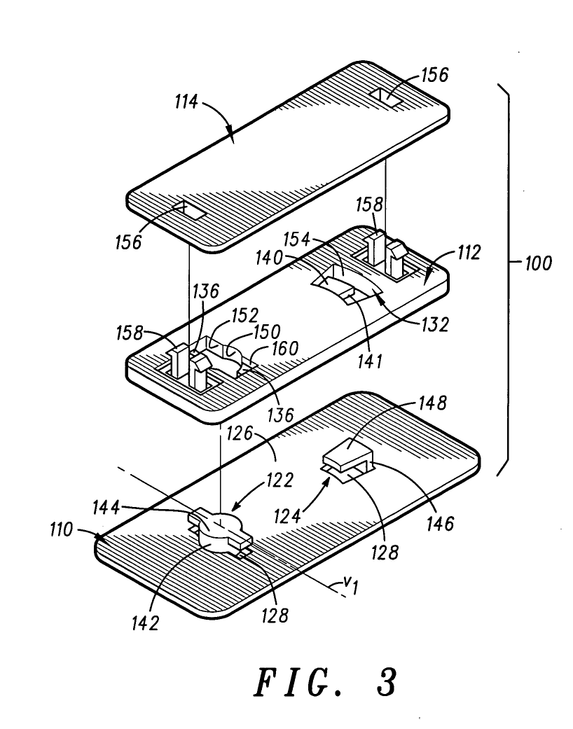

Referring to FIGS. 3 and 4, several of the components of the mechanism 100 are shown. The plate 110 can include a first projection 122 and a second projection 124, both of which can be disposed on a second surface area 126. One or more apertures 128 can be positioned around the first projection 122 and the second projection 124 for molding purposes, as those of ordinary skill in the art will appreciate. The base 112 can include a first slot 130 and a second slot 132.

In one arrangement, the first slot 130 and the second slot 132 can detachably engage the first projection 122 and the second projection 124. For example, the first slot 130 can engage the first projection 122, and the second slot 132 can engage the second projection 124, and as a result, the plate 110 can couple to the base 112. Alternatively, the first slot 130 can disengage the first projection 122, and the second slot 132 can disengage the second projection 124, which can cause the plate 110 to decouple from the base 112.

Specifically, the first slot 130 can include one or more ledges 136, and at least a portion of the ledges 136 can engage at least a portion of the first projection 122 when the first slot 130 engages the first projection 122. Moreover, the second slot 132 can include at least one protrusion 140, and the protrusion 140 can engage at least a portion of the second projection 124 when the second slot 132 engages the second protrusion 124. This process will be described further below.

In one arrangement, the first projection 122 of the plate 110 can include a center portion 142, which can be at least substantially circular, and at least one wing 144. The wings 144 can be attached to the center portion 142 and can extend away from the center portion 142. In one arrangement, the wings 144 can run at least substantially along a vertical axis V₁ (see FIG. 3) of the plate 110. For purposes of the invention, the phrase “at least substantially circular” can include true circular as well as slight or even moderate deviations from true circular, and the phrase “at least substantially along” can include strict adherence with the vertical axis V₁ or slight or even moderate deviations from the vertical axis V₁.

The second projection 124 can include a first segment 146 and a second segment 148 in which the second segment 148 is attached to the first segment 146. In addition, the first segment 146 can be attached to the second surface area 126. In one arrangement, the first segment 146 can rise above the second surface area 126, and the second segment 148 can extend away from the first segment 146. As an example, the second segment 148 can be at least substantially parallel with the second surface area 126, which can cause the second projection 124 to take the shape of hook.

Again, the phrase “at least substantially parallel” can include the second segment 148 being exactly parallel to the second surface area 126, or the second segment 148 can slightly or even moderately deviate from such a true parallel. It is also understood that the invention is not limited to the particular configuration illustrated in FIGS. 3 and 4, as the first projection 122 and the second projection 124 can be disposed on the plate 110 at other suitable locations.

As best shown in FIG. 3, the protrusion 140 can include one or more ridges 141. Additionally, the second segment 148, as best shown in FIG. 4, can include one or more ridges 143. When the second slot 132 engages the second projection 124, the ridges 141 and 143 can frictionally engage one another, which, as will be explained further below, can help keep the plate 110 in a particular position.

The first slot 130 can include at least one arc 150 and at least one extension 152 in which the extensions 152 extend away from the arcs 150. In one arrangement, the arcs 150 can engage the center portion 142 of the first projection 122, and the extensions 152 can receive the wings 144 of the first projection 122. When the plate 110 is turned to a particular position, the ledges 136 can engage the wings 144.

The base 112 can include a vertical axis V₂ (see FIG. 4), and in one arrangement, the first slot 130 can run at least substantially along a first axis A₁ in which the first axis A₁ is at a predetermined angle with respect to the vertical axis V₂. The predetermined angle can be any suitable angle, including an angle of zero degrees in which the first axis A₁ is parallel with the vertical axis V₂.

In addition to the protrusion 140, the second slot 132 can also include at least one arc 154. As will be described further below, at least a portion of the first segment 146 can slide along the arc 154 when the plate 110 is moved. In another arrangement, at least a portion of the second slot 132 can run along a second axis A₂. As an example, this second axis A₂ can be at least substantially perpendicular to the first axis A₁. For purposes of the invention, the phrase “at least substantially perpendicular” can include true perpendicular with the first axis A₁ or slight or even moderate deviations from true perpendicular with the first axis A₁. It should also be noted that the first slot 130 and the second slot 132 can run along any other suitable axes.

The support unit 114 can include one or more slots 156, and the base 112 can include one or more tabs 158. These slots 156 can be configured to receive and engage the tabs 158 of the base 112, which can provide a means for the base 112 to be secured to the support unit 114. It is understood, however, that the invention is not limited in this regard, as any other suitable structure can be used to secure the base 112 to the support unit 114.

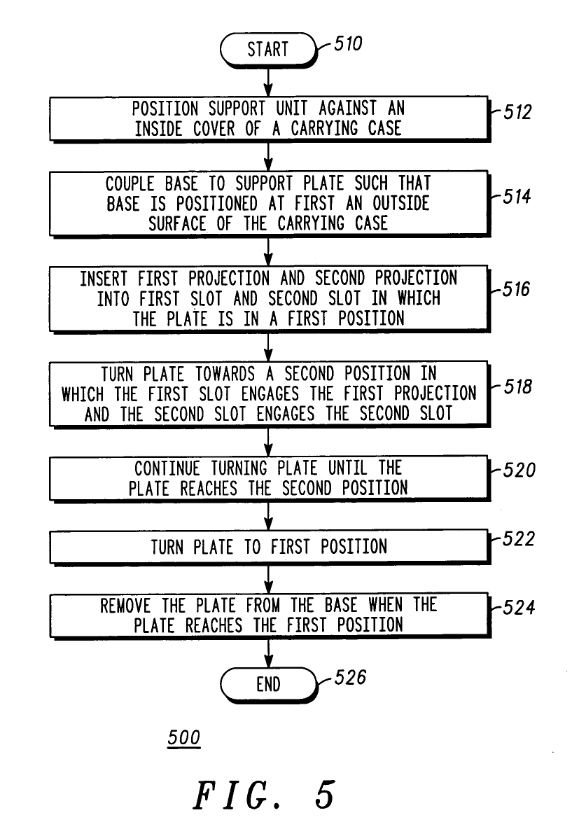

Referring to FIG. 5, a method 500 is shown that illustrates the overall operation of the invention. Reference will be continuously made to FIGS. 1-4 and 6-7 when describing the steps of the method 500. Although reference is made to the mechanism 100 to describe the method 500, it is understood that the method 500 can be practiced with any other suitable mechanism or system.

At step 510, the method 500 can begin. At step 512, the support unit 114 can be positioned against, for example, an inside cover of the carrying case 116. Referring to FIGS. 1 and 2, the portion of the carrying case 116 illustrated can include one or more apertures 162 that can receive the slots 156 of the support unit 114. When the support unit 116 is positioned up against an inside cover 164 of the carrying case 116, the slots 156 can be aligned with the apertures 162 of the carrying case 116.

Referring back to FIG. 5, at step 514, the base 112 can be coupled to the support unit 114 such that the base 112 is positioned against an outside surface of the carrying case 116. For example, moving back to FIGS. 1 and 2, the tabs 158 of the base 112 can engage the slots 156 of the support unit 114. In the process, the base 112 can be positioned against an outside surface 166 of the carrying case 116. Although presented as being incorporated in a carrying case, it must be noted that this description is merely an example; the locking mechanism 100 can be incorporated in any other suitable device.

At step 516, the first projection 122 and the second projection 124 of the plate 110 can be inserted into the first slot 130 and the second slot 132 of the base 112. At this point, the plate 110 is in a first position, which is illustrated in FIG. 6 (FIG. 6 shows a bottom view of the plate 110 and the base 112 in which the plate 110 is in the first position). In this first position, the first slot 130 can detachably receive the first projection 122, and the second slot 132 can detachably receive the second projection 124.

Specifically, the extensions 152 of the first slot 130 can receive the wings 144 of the first projection 122. Additionally, the arcs 150 can receive the center portion 142. The second slot 132 can also receive the first segment 146 and the second segment 148, and the first segment 146 can be positioned close to or in actual contact with the arc 154. When the plate 110 is in the first position, a horizontal axis H₁ of the plate 110 can be at a predetermined angle with respect to a horizontal axis H₂ of the base 112. This predetermined angle can be any suitable angle. In this first position, the plate 110 can be removed from the base 112.

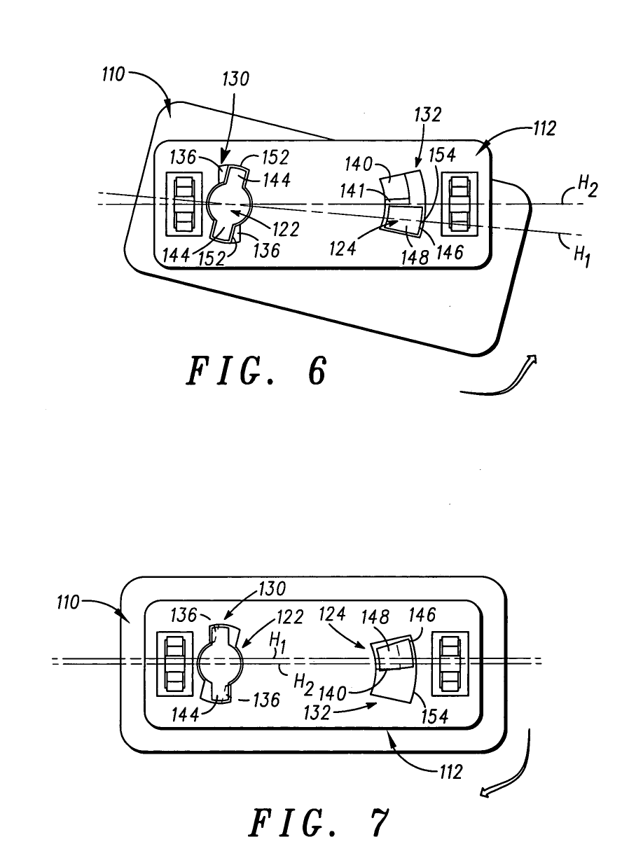

Referring back to FIG. 5, at step 518, the plate 110 can be turned towards a second position, and the first slot 130 can engage the first projection 122, and the second slot 132 can engage the second projection 124. In one arrangement, the second position can be the position where the horizontal axis H₁ of the plate 110 is at least substantially parallel with the horizontal axis H₂ of the base 112, an example of which is illustrated in FIG. 7 (FIG. 7 shows a bottom view of the of the plate 110 and the base 112 in which the plate 110 is in the second position). The phrase “at least substantially parallel” can include true parallel with the horizontal axis H₂ or a slight or even a moderate deviation from this true parallel.

Referring to FIGS. 6 and 7, a user can turn or force the plate 110 towards the second position in a direction in accordance with the arrow shown in FIG. 6. As the plate 110 is turned from the first position to the second position, the ledges 136 of the base 112 (see also FIG. 3) can engage the wings 144 of the first projection 122. Additionally, the protrusion 140 can engage the first segment 146 and the segment 148 of the second projection 124, and at least a portion of the first segment 146 can slide along the arc 154.

Referring back to FIG. 5, the plate 110 can continue to be turned until it reaches the second position, as shown at step 520. Referring once again to FIG. 7, when the plate 110 reaches the second position, the first slot 130 can lock the first projection 122, and the second slot 132 can lock the second projection 124. In this arrangement, the plate 110 can be detachably coupled to the base 112. It is also understood, however, that the first slot 130 locks the first projection 122 and the second slot 132 locks the second projection 124 as the plate 110 is turned towards the second position. This locking process stems from the engagement of the ledges 136 with the wings 144 and the protrusion 140 with the first segment 146 and the second segment 148 during the turning step. Referring to FIGS. 3 and 4 again, the distance that the plate 110 travels to the second position can be based on, at least in part, the wings 144 coming into contact with an inner surface 160 of the first slot 130. This distance can also be based on the second projection 124 coming into contact with an inner surface 162 of the second slot 132.

When the plate 110 is in the second position, the ridges 141 of the protrusion 140 can engage the ridges 143 of the second segment 148. This engagement can help keep the plate 110 in place, particularly if the plate 110 is accidentally bumped.

Continuing with the method 500 of FIG. 5, the plate 110 can also be decoupled from the base 112 in a similar manner. Specifically, at step 522, the plate 110 can be turned to the first position. Moving back to FIGS. 6 and 7, as an example, the user can force the plate 110 in a direction in accordance with the direction of the arrow shown in FIG. 7. In one arrangement, this force can be strong enough to overcome the engagement between the ridges 141 of the protrusion 141 and the ridges 143 of the second segment 148 (see FIGS. 3 and 4). This process can continue until the plate 110 reaches the first position.

When the plate 110 is in the first position, the first slot 130 can disengage the first projection 122. That is, the ledges 136 can disengage the wings 144 of the first projection 122. Moreover, the second slot 132 can disengage the second projection 124 in which the protrusion 140 can disengage the first segment 146 and the second segment 148. At this point, the first slot 130 and the second slot 132 unlock the first projection 122 and the second projection 124, and the plate 110, referring back to FIG. 5, can be removed from the base 112, as shown at step 524. At step 526, the method 500 can end. The user is then free to replace the plate 110 with another plate 110, which may include a different decorative image 120, in accordance with the method 500 described above. As such, the user is free to couple to the base 112 plates 110 with virtually any type of decorative image 120.

It must be noted that the invention is not limited to the particular configuration shown in FIGS. 1-4 and 6-7. For example, the first projection 122 and the second projection 124 can be placed at other suitable locations on the plate 110. Similarly, the first slot 130 and the second slot 132 can be positioned at other suitable locations on the base 112. As another example, the mechanism 100 can be constructed such that a mirror image of the mechanism that is illustrated is created. The overall operation, however, can be in accordance with the description provided above.

In addition, while the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A locking mechanism, comprising:
a plate having a first projection, a second projection and a first surface area for receiving a decorative image; and
a base having a first slot and a second slot, wherein said first slot runs at least substantially along a first axis that is at a predetermined angle with respect to a vertical axis of said base;
wherein said first slot and said second slot detachably receive said first projection when said plate is in a first position, wherein said first slot locks said first projection and said second slot locks said second projection when said plate is in a second position such that said plate is detachably coupled to said base.

2. The mechanism according to claim 1, wherein at least a portion of said second slot runs at least substantially along a second axis that is at least substantially perpendicular to said first axis

3. The mechanism according to claim 1, wherein said first slot and said second slot further lock said first projection and said second projection as said plate is turned from said first position to said second position.

4. The mechanism according to claim 1, wherein said first slot and said second slot unlock said first projection and said second projection when said plate is returned from said second position to said first position, wherein said plate is removable from said base when said plate is in said first position.

5. The mechanism according to claim 1, wherein said first projection has a center portion that is at least substantially circular and at least one wing that is attached to and projects away from said center portion.

6. The mechanism according to claim 5, wherein said first slot includes at least one arc that engages said center portion of said first projection and at least one extension that receives said wings of said first projection.

7. The mechanism according to claim 6, wherein said first slot further includes at least one ledge and said ledges engage said wings as said plate is turned to and stops at said second position.

8. The mechanism according to claim 1, wherein said second projection includes a first segment and a second segment that is attached to said first segment, wherein said first segment is attached to and rises above a second surface area of said plate and said second segment is at least substantially parallel with said second surface area.

9. The mechanism according to claim 8, wherein said second slot includes a protrusion and wherein said first and second segments engage said protrusion as said plate is turned from said first position to said second position and disengage said protrusion when said plate is in said first position.

10. The mechanism according to claim 9, wherein said second slot further includes an arc, wherein at least a portion of said first segment slides along said arc as said plate is turned from said first position to said second position and from said second position to said first position.

11. The mechanism according to claim 1, further comprising a support unit, wherein said base further includes at least one tab and said support unit includes at least one slot for receiving and engaging said tabs of said base.

12. The mechanism according to claim 11, wherein said support unit is positioned against an inside surface of a portion of a carrying case, wherein said base is positioned against an outside surface of the carrying case when said slots of said support unit engage said tabs of said base.

13. The mechanism according to claim 1, wherein said plate includes a horizontal axis and said base includes a horizontal axis, wherein said horizontal axis of said plate is at a predetermined angle with respect to said horizontal axis of said base when said plate is in said first position and said horizontal axis of said plate is at least substantially parallel with said horizontal axis of said base when said plate is in said second position.

14. A plate for a carrying case, comprising:
a first surface area;
a second surface area for receiving a decorative image;
a first projection; and
a second projection, said first and second projections being disposed on said first surface area;
wherein said first and second projections are received by first and second slots of a base when said plate is in a first position, wherein said first and second projections are engaged by the first and second slots as said plate is turned to and stops at a second position, said plate couples to the base when said first and second projections engage the first and second slots and said plate decouples from the base when said plate is in the first position.

15. A base of a carrying case, comprising:
a first slot; and
a second slot, wherein said second slot includes a protrusion;
wherein said first and second slots receive a first projection and a second projection of a plate when the plate is in a first position and said first and second slots engage the first and second projections as the plate is turned to and stops at a second position, wherein the plate couples to said base when said first and second slots engage the first and second projections and the plate decouples from said base when the plate is in the first position.

16. A method of detachably securing a plate to a base of a carrying case, comprising the steps of:
inserting a first projection and a second projection of the plate into a first slot and a second slot of the base, wherein the plate is in a first position;
turning the plate towards a second position, wherein the first slot engages the first projection and the second slot engages the second projection; and
continuing said turning the plate step until the plate reaches the second position.

17. The method according to claim 16, further comprising the steps of:
turning the plate towards the first position; and
when the plate reaches the first position, removing the plate from the base.

18. The method according to claim 17, further comprising the steps of:
positioning a support unit against an inside cover of the carrying case; and
coupling the base to the support unit such that the base is positioned against an outside surface of the carrying case.

19. The method according to claim 16, wherein the plate includes a horizontal axis and the base includes a horizontal axis, wherein the horizontal axis of the plate is at a predetermined angle with respect to the horizontal axis of the base when the plate is in the first position and the horizontal axis of the plate is at least substantially parallel with the horizontal axis of the base when the plate is in the second position.

20. A locking mechanism, comprising:
a plate having a first projection, a second projection and a first surface area for receiving a decorative image; and
a base having a first slot and a second slot;
wherein said first slot and said second slot detachably receive said first projection when said plate is in a first position, wherein said first slot locks said first projection and said second slot locks said second projection when said plate is in a second position such that said plate is detachably coupled to said base.

21. The locking mechanism according to claim 20, wherein said first slot runs at least substantially along a first axis that is at a predetermined angle with respect to a vertical axis of said base.

22. The locking mechanism according to claim 21, wherein at least a portion of said second slot runs at least substantially along a second axis that is at least substantially perpendicular to said first axis
